(19) United States
(12) Patent Application Publication
(10) Pub. No.: US 2016/0162979 A1
(43) Pub. Date: Jun. 9, 2016

(54) Global Positioning System Based Service Provider Locator

(71) Applicant: Corey Leonard Robinson, Davie, FL (US)

(72) Inventor: Corey Leonard Robinson, Davie, FL (US)

(21) Appl. No.: 14/956,975

(22) Filed: Dec. 2, 2015

Related U.S. Application Data
(60) Provisional application No. 62/087,464, filed on Dec. 4, 2014.

(51) Int. Cl. G06Q 30/06

(52) U.S. Cl. CPC G06Q 30/0639; G06Q 30/0641

(57) ABSTRACT

A method for providing same day service listings using a software-based application and website locator system. A user makes service selection for a particular service from a plurality of service categories through a graphical user interface of a personal computing device. The user then enters personal location data and a service radius in which to search for a plurality of businesses for the particular service. A remote server receives the service selection, the personal location data, and the service radius, and sends out a signal within the service radius in order to gather business location data for each of the plurality of businesses. The business location data for each of the plurality of businesses is then compared to the personal location data, wherein each of the plurality of businesses is listed by closest proximity to a current location of the user.

The current application claims a priority to the U.S. Provisional Patent application Ser. No. 62/087,464 filed on Dec. 4, 2014.

### FIELD OF THE INVENTION

The present invention relates generally to a service provider locator system. More specifically, the present invention is a software-based application and website locator system that provides same day professional service.

### BACKGROUND OF THE INVENTION

In many service industries it is common for consumers to be in search of same day services for a number of different reasons. In order to provide same day services it requires the consumer and the business, or a single employee of the business, to be in relatively close proximity to one another in order for the business to be able to accommodate the consumer and provide the desired service. Many businesses have employees that travel from one location to another throughout the workday due to the nature of the service provided, so it is possible that an employee is within close proximity to the consumer looking for same day services. However, it is not possible for the consumer to know the current location of the employee, only the primary fixed location of the business, and thus the consumer may not think to contact the particular business. This can lead to missed opportunities for a business and a consumer with fewer apparent options for same day services.

Therefore it is the object of the present invention to provide a software-based application and website locator system for providing same day professional service. The present invention tracks businesses and the mobile employees of each business in order to provide a user with a list of nearby service providers that is compiled in real-time. The user enters personal location data and a service radius, along with a service selection for the particular service that is desired, in order to generate the list of nearby service providers. A signal is sent to all service providers within the service radius, wherein the business location data for each of the service providers is compared to the personal location data. The service providers are then listed in order of closest proximity to the current location of the user, along with a business rating and reviews for each service provider, wherein the user can select the desired service provider to contact.

### BRIEF DESCRIPTION OF THE DRAWINGS

FIG. 1 is a flowchart depicting the steps for providing a user with a list of local businesses that provide same day services.

FIG. 2 is a flowchart further depicting how personal location data for the user is gathered by the remote server.

FIG. 3 is a flowchart further depicting the steps of locating local businesses within a service radius of the current location of the user.

FIG. 4 is a flowchart further depicting the steps for displaying the plurality of businesses in a manner other than closest proximity to the current location.

FIG. 5 is a flowchart further depicting steps for accessing a company profile page for a particular business from the plurality of businesses.

FIG. 6 is a flowchart further depicting the step of displaying a business rating for each of the plurality of businesses on the business listings page.

FIG. 7 is a flowchart further depicting steps for communicably connecting the user to a particular business via a voice chat application.

FIG. 8 is a flowchart further depicting steps for communicably connecting the user to a particular business via a digital-messaging chat application.

FIG. 9 is a flowchart further depicting steps for providing the user with access to a service savings page for the particular business.

FIG. 10 is a flowchart further depicting steps for tracking a mobile employee in order to obtain business location data for listing the plurality of businesses to the user.

### DETAIL DESCRIPTIONS OF THE INVENTION

All illustrations of the drawings are for the purpose of describing selected versions of the present invention and are not intended to limit the scope of the present invention.

The present invention is a software-based application and website locator system for providing same day professional service. The present invention provides a user with the ability to search through a plurality of service categories in order to find a service provider for a particular service selected from the plurality of service categories. A remote server is used to store a database of a plurality of service providers, wherein each of the plurality of service providers is associated with at least one type of service from the plurality of service categories.

The remote server can be accessed by a user through a personal computing device that is able to wirelessly connect to the remote server. A graphical user interface displayed on the personal computing device allows the user to access and view the desired content stored on the remote server. The graphical user interface can be provided through a web browser or through an exclusive software application downloaded onto the personal computing device.

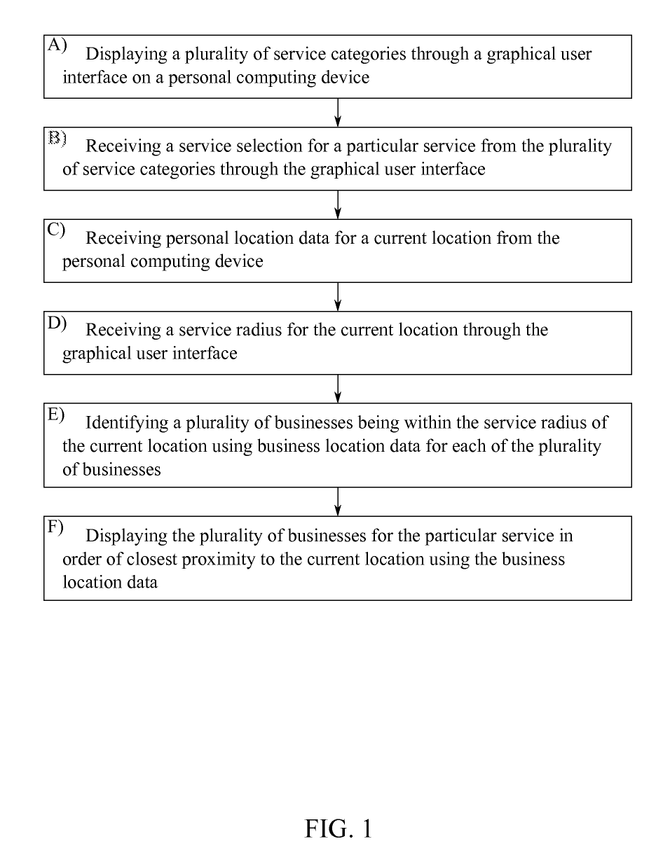

In reference to FIG. 1, the graphical user interface is used to display the plurality of service categories to the user through the personal computing device. The plurality of service categories can be displayed in a number of different ways according to the layout and overall design of the graphical user interface. In the preferred embodiment of the present invention, the plurality of service categories is displayed in two different ways: the plurality of service categories is displayed in a table on the graphical user interface homepage and the plurality of service categories is displayed in a list through a drop down input field.

In further reference to FIG. 1, the user makes a service selection for a particular service from the plurality of service categories through the graphical user interface. Typically, the service selection is made by tapping or clicking on the particular service in the table of the plurality of service categories or in the list from the drop down input field. It is also possible for the service selection to be made by typing the particular service into a search field. The personal computing device receives the service selection for the particular service through the graphical user interface, wherein the service selection is relayed to and received by the remote server. The remote server then uses the service selection to display a plurality of businesses for the particular service.

Prior to displaying the plurality of businesses, the remote server receives additional data pertaining to the user. More specifically and in reference to FIG. 1, the remote server receives personal location data for a current location from the personal computing device and a service radius for the current location that is entered through the graphical user interface. The personal location data provides the starting point around which the remote server searches for the plurality of businesses to be displayed to the user. Meanwhile, the service radius defines the size of the searchable area around the current location from which each of the plurality of businesses is selected.

When the drop down input field is used to display the plurality of service categories, a location input field for the personal location data and a radius input field for the service radius are also provided. The user makes the service selection from the drop down input field, the personal location data is entered into the location input field, and the service radius is entered into the radius input field. The value of the service radius may be selected from a list of predefined values (i.e. a drop down list) or entered manually as any value chosen by the user. The personal location data can be entered into the location input field in one of two ways depending on the personal computing device that is being used and depending on the needs of the user.

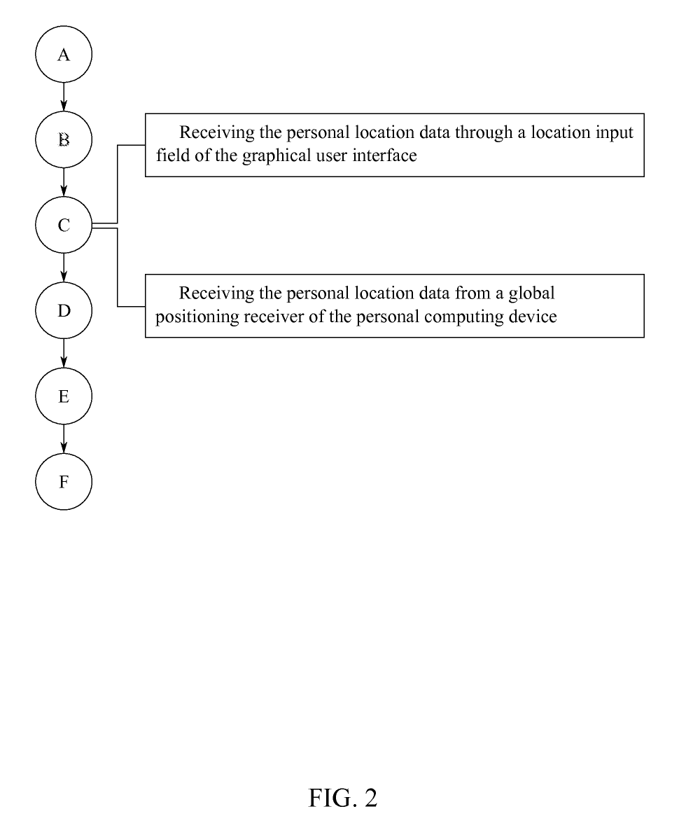

In reference to FIG. 2, the first way in which the personal location data can be entered into the location input field is manually, wherein the user enters an address, zip code, etc. In this way, the current location does not have to be the exact location of the user. For example, if the user is out running errands but wishes to find services that are located around the user's home, then the user can manually enter the personal location data. The second way in which the personal location data can be entered into the location input field is via a global positioning receiver of the personal computing device. The global positioning receiver utilizes the global positioning system, or a similar standard, to determine the personal location data for the current location of the personal computing device; the current location being the exact location of the personal computing device. Once the global positioning receiver determines the personal location data, the personal location data is automatically entered into the location input field.

The personal location data and the service radius can be received by the remote server at the same time as the service selection, or after the service selection has been received. When the drop down input field is provided for selecting the particular service, the location input field and the radius input field can be provided as well, such that the user may enter all information at once. If the particular service is selected from the plurality of service categories being displayed in a table or list, then the location input field and the radius input field are provided on a service page to which the user is redirected; the service page being webpage or application page dedicated to the particular service.

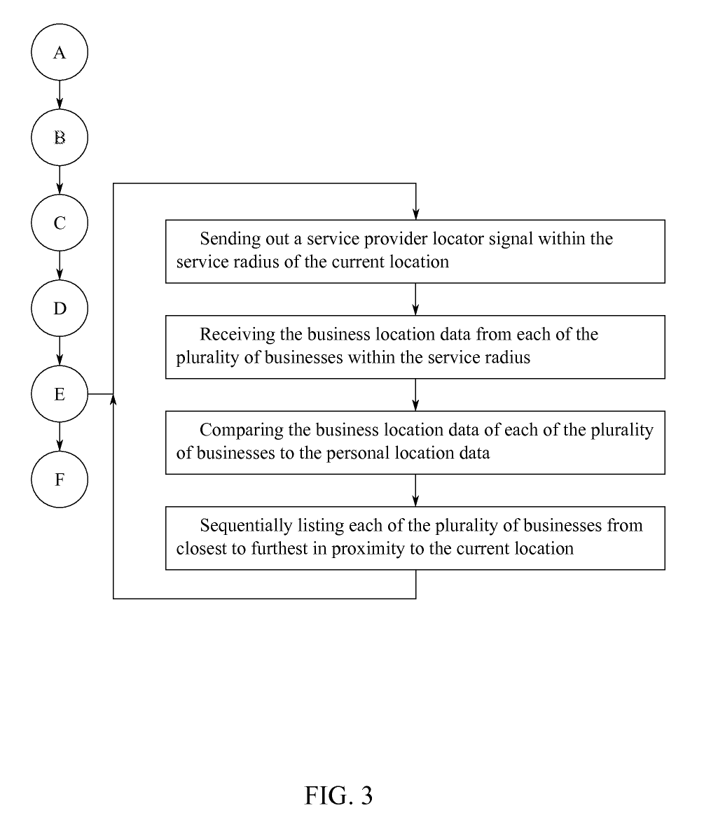

Once the remote server has received the service selection, the personal location data, and the service radius, the remote server identifies the plurality of businesses within the service radius of the current location. In reference to FIG. 3, in order to identify the plurality of businesses, the remote server utilizes business location data of each of the plurality of businesses; the business location data being for either a stationary business location or a current mobile location. The remote server sends out a service provider locator signal within the service radius of the current location in order to identify any business currently within the service radius of the current location. In turn, the remote server receives the business location data from each of the plurality of businesses within the service radius.

In reference to FIG. 1, the remote server then displays the plurality of businesses for the particular service in order of closest proximity to the current location using the business location data on a business listings page. In reference to FIG. 3, the proximity of each of the plurality of businesses to the current location is determined by comparing the business location data of each of the plurality of businesses to the personal location data, wherein the distance between the current location and either the stationary business location or the current mobile location is computed. Once the remote server has compared the business location data for each of the plurality of businesses to the personal location data, the remote server sequentially lists each of the plurality of businesses from closest to furthest in proximity to the current location.

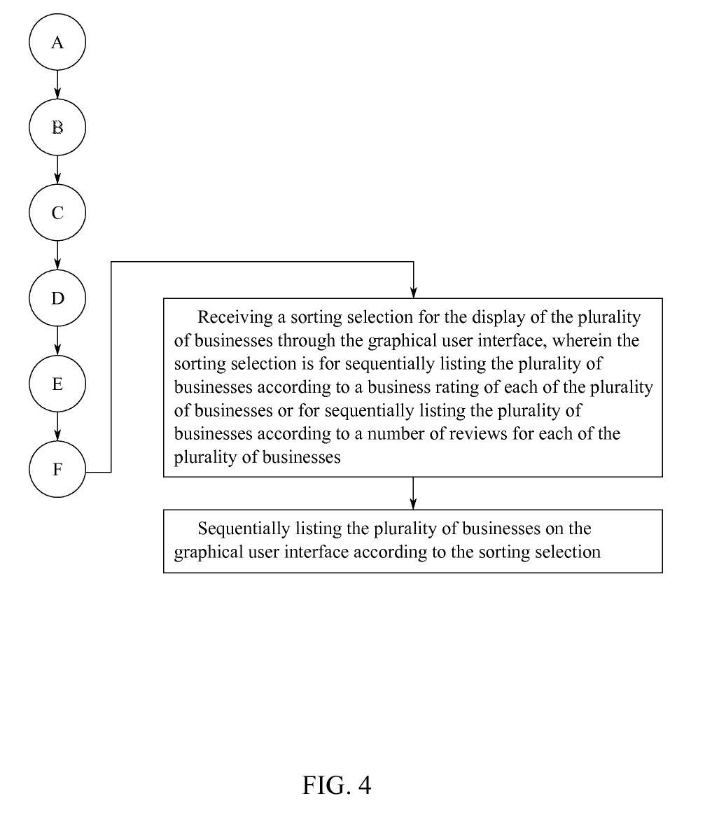

In reference to FIG. 4, the plurality of businesses can also be listed in an order other than closest proximity to the current location if the user desires. Through a sorting input field, the user can chose a sorting selection from a drop down list, wherein the remote server receives the sorting selection for the display of the plurality of businesses through the graphical user interface. The remote server then sequentially lists the plurality of businesses on the graphical user interface according to the sorting selection. In addition to sequentially listing the plurality of businesses by closest proximity, the sorting selection can be for sequentially listing the plurality of businesses according to a business rating of each of the plurality of business or for sequentially listing the plurality of businesses according to a number of reviews for each of the plurality of businesses.

In the preferred embodiment of the present invention, the business rating for each of the plurality of businesses is an integer value from one to five; one being the worst reviewed and five being the best reviewed. The remote server sequentially lists the plurality of businesses from best reviewed to worst reviewed when the sorting selection is for sequentially listing the plurality of businesses according to the business rating of each of the plurality of businesses. When the sorting selection is for sequentially listing the plurality of businesses according to the number of reviews, the remote server sequentially lists the plurality of businesses from the business with the most reviews to the business with the least reviews.

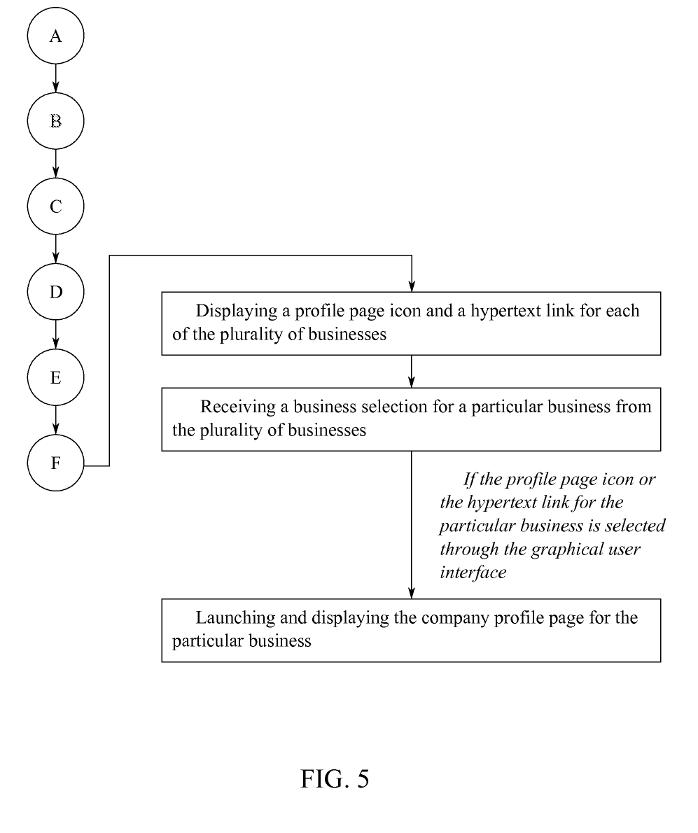

The remote server displays the plurality of businesses on the business listings page, wherein the user is able to make business selection for a particular business from the plurality of businesses. In reference to FIG. 5, the listings page displays a profile page icon and a hypertext link for each of the plurality of businesses, both of which can be used to access a company profile page for the particular business. If either the profile page icon or the hypertext link for the particular business is selected through the graphical user interface, then the remote server launches the company profile page for the particular business, wherein the company profile page is displayed through the graphical user interface.

The company profile page presents the business rating for the particular business, along with contact information and service information for the particular business. The contact information may include, but is not limited to, a phone number, address, email address, fax number, etc. Meanwhile, the service information may include, but is not limited to, a company overview, a listing of services provided, pricing for each of the services provided, hours of operation, company photos, etc. The user can utilize the business rating and the service information to determine whether or not the user wishes to procure the services of the particular business, wherein the contact information can be utilized by the user to contact the particular business if the user wishes to use the particular business.

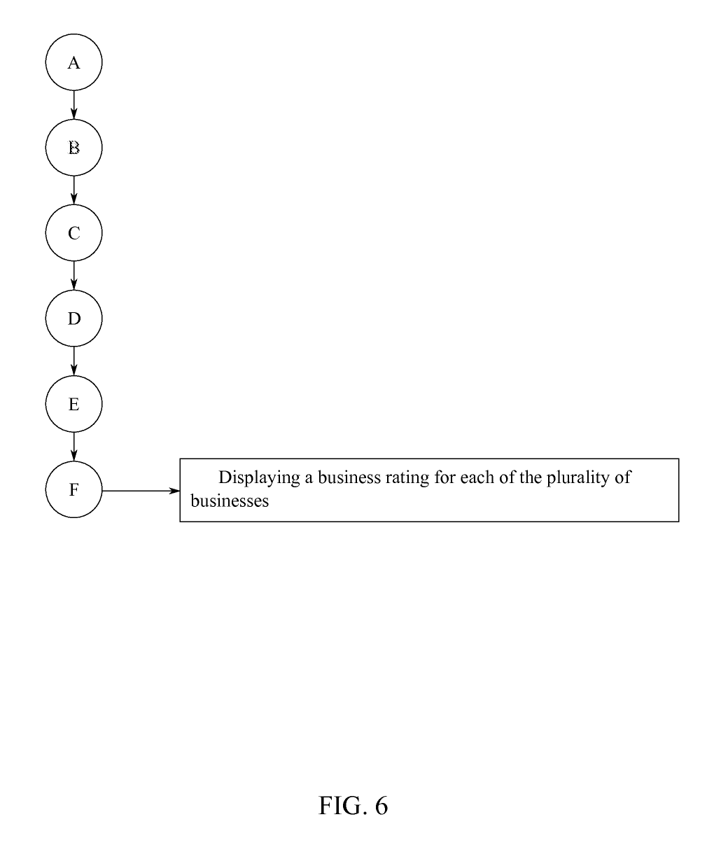

In addition to the profile page icon and the hypertext link, the business listings page displays the business rating, a voice contact icon, a digital-messaging contact icon, and a savings icon for each of the plurality of businesses, as depicted by FIG. 6-9 respectively. The voice contact icon, the digital-messaging contact icon, and the savings icon can also be displayed on the company profile page for each of the plurality of businesses. The voice contact icon connects the user to the particular business via voice chat, while the digital-messaging contact icon connects the user to the particular business via text chat. The savings icon directs the user to coupons, deals, etc. for the particular business.

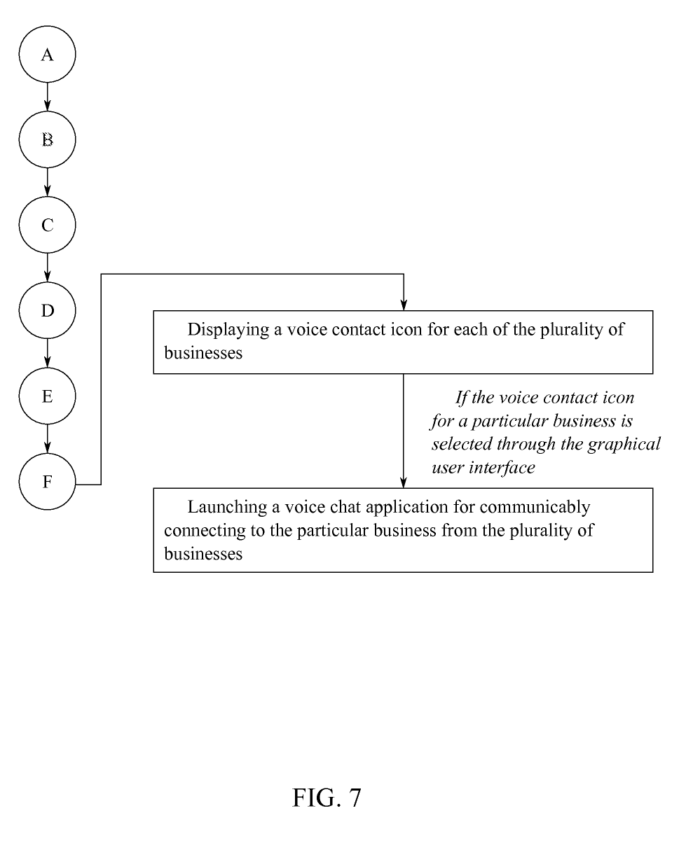

In reference to FIG. 7, if the voice chat icon for the particular business is selected through the graphical user interface, then the remote server launches a voice chat application for communicably connecting the user to the particular business. The voice chat application can be a standalone software application, an extension integrated into a web browser, a software application integrated into the exclusive software application of the present invention, etc. When the voice chat application is launched, the remote server automatically retrieves the phone number for the particular business, wherein the user simply has to initiate the call to dial the phone number.

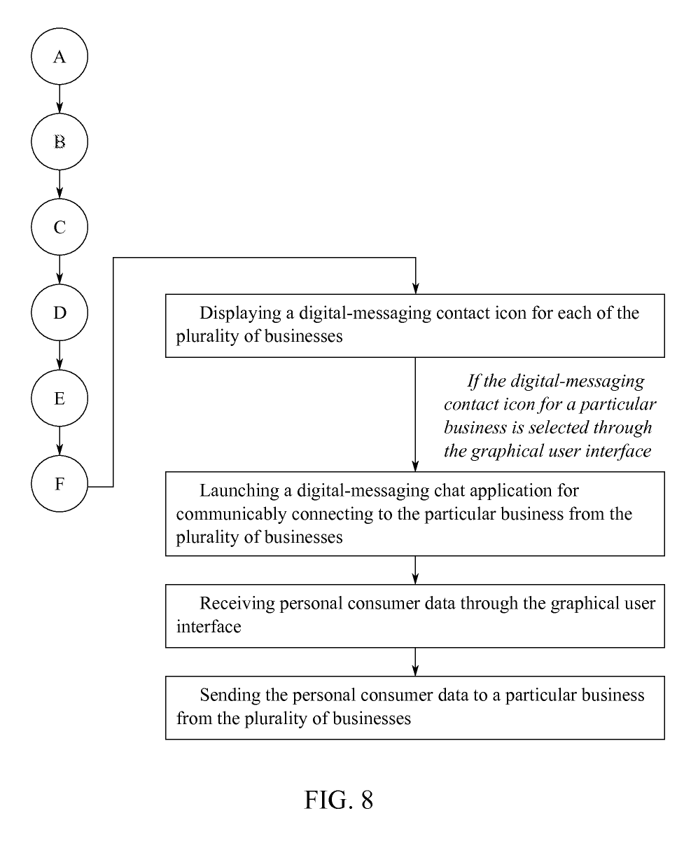

In reference to FIG. 8, if the digital-messaging contact icon for the particular business is selected through the graphical user interface, then the remote server launches a digital-messaging chat application for communicably connecting the user to the particular business. Similar to the voice chat application, the digital-messaging chat application can be a standalone software application, an extension integrated into a web browser, a software application integrated into the exclusive software application of the present invention, etc. The digital-messaging chat application allows the user to communicate with the particular business via text, wherein the user can send personal consumer data, such as contact information and service requests, to particular business. The remote server receives the personal consumer data through the graphical user interface and sends the personal consumer data to the particular business, wherein the particular business can respond to the user via the provided contact information of the user.

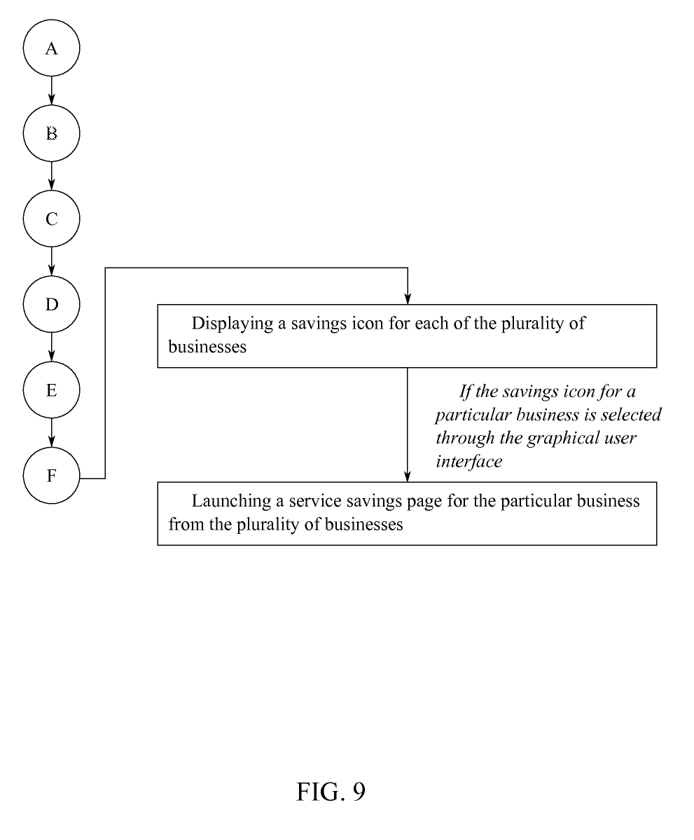

In reference to FIG. 9, if the savings icon for the particular business is selected through the graphical user interface, then the remote server launches a service savings page for the particular business. The service savings page provides the users with deals, coupons, discounts, and other types of savings that can be applied to services provided by the particular business. The service savings page can be a listing of offers from third parties, or the service savings page can be a third party site or page to which the user is redirected by the remote server. The user can then apply the offers discovered through the service savings page to services provided by the particular business when the user contacts the particular business.

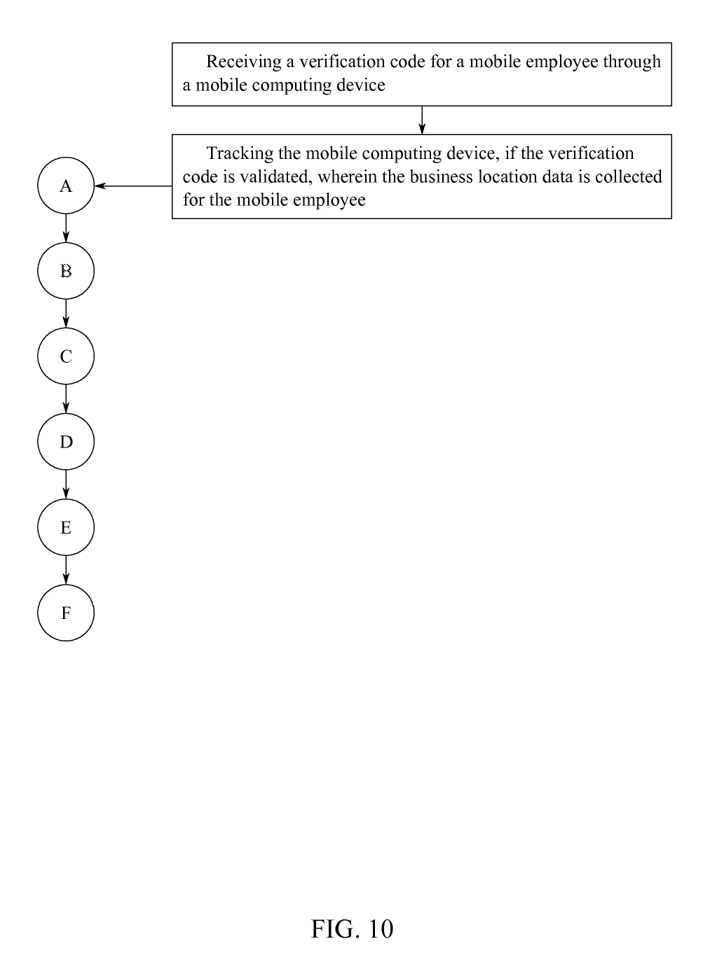

In reference to FIG. 10, another aspect of the present invention is the tracking of employees for each of the plurality of businesses. The exclusive software application is installed on a mobile computing device of a mobile employee, wherein the remote server tracks the location of the mobile computing device. In order to track the mobile computing device, the mobile employee must first enter a verification code to register the mobile computing device with remote server and the particular business for which the mobile employee works. The remote server receives the verification code and validates the verification code with the particular business to ensure that the mobile employee is an employee of the particular business. If the verification code is authorized, then the remote server tracks the mobile computing device, wherein the remote server collects the business location data for the mobile employee and shares the business location data when consumers perform search queries for local businesses.

Although the invention has been explained in relation to its preferred embodiment, it is to be understood that many other possible modifications and variations can be made without departing from the spirit and scope of the invention as hereinafter claimed.

What is claimed is:

1. A method for providing same day service listings by executing computer-executable instructions stored on a non-transitory computer-readable medium, the method comprises the steps of:
displaying a plurality of service categories through a graphical user interface on a personal computing device;
receiving a service selection for a particular service from the plurality of service categories through the graphical user interface;
receiving personal location data for a current location from the personal computing device;
receiving a service radius for the current location through the graphical user interface;
identifying a plurality of businesses being within the service radius of the current location using business location data for each of the plurality of businesses; and
displaying the plurality of businesses for the particular service in order of closest proximity to the current location using the business location data.

2. The method for providing same day service listings by executing computer-executable instructions stored on a non-transitory computer-readable medium, the method as claimed in claim 1 further comprises the steps of:
receiving the personal location data through a location input field of the graphical user interface.

3. The method for providing same day service listings by executing computer-executable instructions stored on a non-transitory computer-readable medium, the method as claimed in claim 1 further comprises the steps of:
receiving the personal location data from a global positioning receiver of the personal computing device.

4. The method for providing same day service listings by executing computer-executable instructions stored on a non-transitory computer-readable medium, the method as claimed in claim 1 further comprises the steps of:
sending out a service provider locator signal within the service radius of the current location; and
receiving the business location data from each of the plurality of businesses within the service radius.

5. The method for providing same day service listings by executing computer-executable instructions stored on a non-transitory computer-readable medium, the method as claimed in claim 1 further comprises the steps of:
comparing the business location data of each of the plurality of businesses to the personal location data; and
sequentially listing each of the plurality of businesses from closest to furthest in proximity to the current location.

6. The method for providing same day service listings by executing computer-executable instructions stored on a non-transitory computer-readable medium, the method as claimed in claim 1 further comprises the steps of:
receiving a sorting selection for the display of the plurality of businesses through the graphical user interface; and
sequentially listing the plurality of businesses on the graphical user interface according to the sorting selection.

7. The method for providing same day service listings by executing computer-executable instructions stored on a non-transitory computer-readable medium, the method as claimed in claim 6, wherein the sorting selection is for sequentially listing the plurality of businesses according to a business rating of each of the plurality of businesses.

8. The method for providing same day service listings by executing computer-executable instructions stored on a non-transitory computer-readable medium, the method as claimed in claim 6, wherein the sorting selection is for sequentially listing the plurality of businesses according to a number of reviews for each of the plurality of businesses.

9. The method for providing same day service listings by executing computer-executable instructions stored on a non-transitory computer-readable medium, the method as claimed in claim 1 further comprises the steps of:
receiving a business selection for a particular business from the plurality of businesses; and
displaying a company profile page for the particular business, wherein the company profile page displays a business rating, contact information, and service information.

10. The method for providing same day service listings by executing computer-executable instructions stored on a non-transitory computer-readable medium, the method as claimed in claim 9 further comprises the steps of:
displaying a profile page icon for each of the plurality of businesses; and
launching the company profile page for the particular business, if the profile page icon for the particular business is selected through the graphical user interface.

11. The method for providing same day service listings by executing computer-executable instructions stored on a non-transitory computer-readable medium, the method as claimed in claim 9 further comprises the steps of:
displaying a hypertext link for each of the plurality of businesses; and
launching the company profile page for the particular business, if the hypertext link for the particular business is selected through the graphical user interface.

12. The method for providing same day service listings by executing computer-executable instructions stored on a non-transitory computer-readable medium, the method as claimed in claim 1 further comprises the steps of:
displaying a voice contact icon for each of the plurality of businesses; and
launching a voice chat application for communicably connecting to a particular business from the plurality of businesses, if the voice contact icon for the particular business is selected through the graphical user interface.

13. The method for providing same day service listings by executing computer-executable instructions stored on a non-transitory computer-readable medium, the method as claimed in claim 1 further comprises the steps of:
displaying a digital-message contact icon for each of the plurality of businesses; and
launching a digital-messaging chat application for communicably connecting to a particular business from the plurality of businesses, if the digital-message contact icon for the particular business is selected through the graphical user interface.

14. The method for providing same day service listings by executing computer-executable instructions stored on a non-transitory computer-readable medium, the method as claimed in claim 1 further comprises the steps of:
displaying a savings icon for each of the plurality of businesses; and
displaying a service savings page for a particular business from the plurality of businesses, if the savings icon for the particular business is selected through the graphical user interface.

15. The method for providing same day service listings by executing computer-executable instructions stored on a non-transitory computer-readable medium, the method as claimed in claim 1 further comprises the steps of:
displaying a business rating for each of the plurality of businesses.

16. The method for providing same day service listings by executing computer-executable instructions stored on a non-transitory computer-readable medium, the method as claimed in claim 1 further comprises the steps of:
receiving personal consumer data through the graphical user interface; and
sending the personal consumer data to a particular business from the plurality of businesses.

17. The method for providing same day service listings by executing computer executable instructions stored on a non-transitory computer-readable medium, the method as claimed in claim 1 further comprises the steps of:
receiving a verification code for a mobile employee through a mobile computing device; and
tracking the mobile computing device, if the verification code is validated, wherein the business location data is collected for the mobile employee.
